(19) United States
(12) Patent Application Publication
(10) Pub. No.: US 2023/0087446 A1
(43) Pub. Date: Mar. 23, 2023

(54) NETWORK MONITORING METHOD, ELECTRONIC DEVICE AND STORAGE MEDIUM

(71) Applicant: ZTE CORPORATION, Shenzhen, Guangdong (CN)

(72) Inventor: Guangyan Li, Shenzhen, Guangdong (CN)

(21) Appl. No.: 17/908,939

(22) PCT Filed: Jun. 11, 2021
(86) PCT No.: PCT/CN2021/099765

§ 371 Date: Sep. 2, 2022

(30) Foreign Application Priority Data
Jun. 12, 2020 (CN) 202010537432.1

(51) Int. Cl. H04L 41/0677; H04L 41/0681

(52) U.S. Cl. CPC H04L 41/0677; H04L 41/0681

(57) ABSTRACT

The embodiments of the present application provide a network monitoring method, an electronic device and a storage medium. The method includes: in response to receiving abnormal information reported by a network node, determining a suspicious region according to the abnormal information, the abnormal information is transmitted to the network management system from the network node in response to detecting by the network node that a network transmission index is abnormal; transmitting an acquisition instruction to the network node within the suspicious region, wherein the acquisition instruction includes an order for acquiring a device performance index of the network node; receiving the device performance index returned, in response to the acquisition instruction, by the network node within the suspicious region; and generating an abnormality analysis report according to the device performance index.

### CROSS-REFERENCE TO RELATED APPLICATIONS

This application is proposed based on and claims the priority of the Chinese patent application No. 202010537432.1 filed on Jun. 12, 2020, the contents of which are incorporated herein by reference in its entirety.

### TECHNICAL FIELD

Embodiments of the application relate to the technical field of communications, and in particular, to a network monitoring method, an electronic device and a storage medium.

### BACKGROUND

With the rapid development of communication networks, more and more network devices are included in the communication network. In order to ensure services of a communication network to be performed normally, it is required to monitor the network performance of the communication network to determine whether the communication network is in a normal working state. When monitoring the network performance of the communication network, a network management system is usually used to poll a network transmission index in the communication network, such as an index of latency time, an index of jitter, and an index of packet loss rate, or poll a device performance index of a network node in the communication network, such as an index of a central processing unit (CPU for short), an index of an internal storage, an index of a routing table, and an index of an interface (including a count of incoming packets and a count of outgoing packets). In a specific process of polling the network transmission index or the device performance index, the network management system usually transmits a configuration instruction to the network node, and the network node acquires the corresponding index at a fixed time instant according to the configuration instruction and returns the network transmission index or the device performance index obtained to the network management system.

There is a relatively long time interval for polling a performance index of each network device in relevant methods. Thus, the abnormality of the network performance cannot be determined in time.

### SUMMARY

An embodiment of the present application provides a network monitoring method, applied to a network management system and including: in response to receiving abnormal information reported by a network node, determining a suspicious region according to the abnormal information, the abnormal information being transmitted to the network management system from the network node in response to detecting by the network node that the a network transmission index is abnormal; transmitting an acquisition instruction to the network node within the suspicious region, the acquisition instruction including an order for acquiring a device performance index of the network node; receiving the device performance index returned, in response to the acquisition instruction, by the network node within the suspicious region; and generating an abnormality analysis report according to the device performance index.

An embodiment of the present application further provides a network monitoring method, applied to a network node and including: receiving an acquisition instruction transmitted from a network management system, the acquisition instruction including an order for acquiring a device performance index of the network node; and collecting the device performance index and returning the device performance index to the network management system.

An embodiment of the application further provides an electronic device, including: at least one processor; and a memory communicatively connected to the at least one processor. The memory is configured to store an instruction executable by the at least one processor, and the instruction is executed by the at least one processor to enable the at least one processor to implement the above network monitoring method.

An embodiment of the application further provides a computer readable storage medium with a computer program stored thereon. The computer program, when executed by a processor, causes to implement the above network monitoring method.

### BRIEF DESCRIPTION OF THE DRAWINGS

One or more embodiments are exemplarily described with reference to corresponding accompanying drawings, and the exemplary description does not constitute any limitation on the embodiments. Elements with the same reference numeral in the accompanying drawings denote similar elements, and unless otherwise stated, the accompanying drawings do not constitute any limitation on the proportion.

FIG. 1 is a schematic diagram illustrating an application scenario of a network monitoring method provided in an embodiment;

FIG. 2 is a schematic flowchart of a network monitoring method provided in an embodiment;

FIG. 3 is schematic flowchart I of a network monitoring method provided in another embodiment;

FIG. 4 is schematic flowchart II of a network monitoring method provided in another embodiment;

FIG. 5 is schematic flowchart III of a network monitoring method provided in another embodiment; and

FIG. 6 is a schematic structural diagram of an electronic device provided in an embodiment.

### DETAILED DESCRIPTION

Embodiments of the present application provide a network monitoring method, an electronic device, and a storage medium, so that an abnormality of a network device can be determined in time.

In order to make the objectives, technical solutions, and advantages of the embodiments of the present application clearer, respective embodiments of the application will be elaborated in conjunction with the accompanying drawings. However, those of ordinary skill in the art may understand that, in respective embodiments of the application, many technical details are put forward for better understanding of the application by the reader. However, the technical solutions of the present application may be implemented even without these technical details and various changes and modifications based on the following respective embodiments. The following division of respective embodiments is for the convenience of description and should not constitute any limitation on specific implementation manners of the application, and respective embodiments are not contradictory with each other.

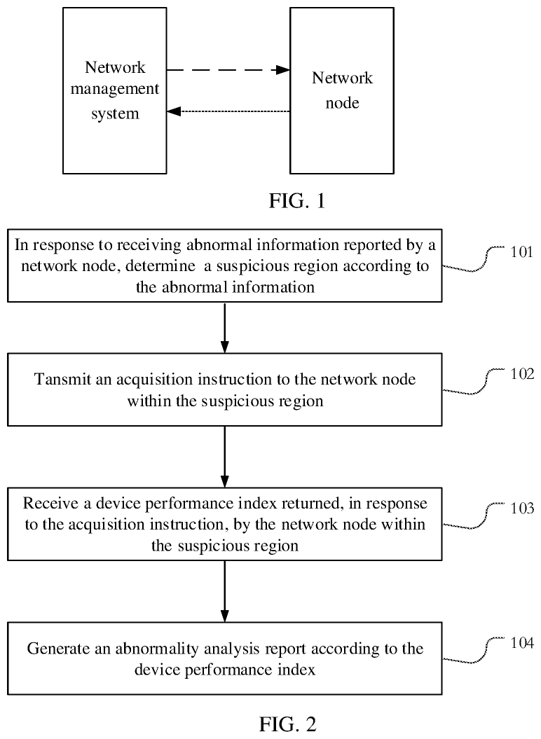

FIG. 1 is a schematic diagram illustrating an application scenario of a network monitoring method provided in an embodiment of the present application. As shown in FIG. 1, the scenario includes a network management system and a network node which are communicatively connected. In response to an instruction issued by the network management system, the network node may transmit a device performance index and/or a network transmission index collected to the network management system.

In the case that the device performance index or the device performance index of the network node in a communication network is acquired, by performing polling, by means of the network management system, the index/indexes obtained is acquired at a fixed time instant. If a time instant when a network performance abnormality occurs in the communication network is not a time instant of acquiring the index, an abnormal index cannot be acquired in time, so that the abnormality of the network performance cannot be determined in time.

FIG. 2 is a schematic flowchart of a network monitoring method provided in an embodiment of the application. The present embodiment relates to a specific process of acquiring abnormal network performance in time. Implementation details of the network monitoring method in the present embodiment are described specifically below, and the following contents are implementation details provided for better understanding only and are not necessary for implementing the solution. As shown in FIG. 2, the method includes steps described below.

At step 101, in response to receiving abnormal information reported by a network node, a suspicious region is determined according to the abnormal information.

In response to detecting that a network transmission index is abnormal, the network node transmits the abnormal information to a network management system.

For example, the network node may include a user networks interface (UNI for short) or a network to network interface (NNI for short). The network management system (NMS for short) may be configured to monitor a working state of each of network nodes, so as to determine a current communication state of the communication network.

In an embodiment, when determining the current communication state of the communication network, the NMS usually acquires a network transmission index of the communication network. For example, the NMS configures the UNI as a test transmitting end and configures the NNI as a test reflecting end. The UNI acquires a network transmission index between the UNI and the NNI through a two-way active measurement protocol (TWAMP for short), and reports the network transmission index acquired to the NMS.

In an embodiment, before acquiring the network transmission index between the UNI and the NNI through the TWAMP, a slice network is usually created between the UNI and the NNI, including: planning the network resource, such as a device, an interface, a link, and a tunnel between the UNI and the NNI, determining a device required for the slice network from a physical topology, and performing resource synchronization; further examining the resource subjected to the synchronization to determine whether the network resource planed is sufficient; then requesting for the resource planed, and locking the requested network resource to prevent other services from using the requested network resource; and then issuing a service configuration, a TWAMP configuration, and configuration of a telemetry performance index subscription to the requested network resource.

In an embodiment, the service configuration includes: interface creation, configuration of an internet protocol (IP for short) address for the interface, configuration of an interior gateway protocol (IGP), configuration of a level 2 virtual private network (L2VPN for short), and configuration of a level 3 virtual private network (L3VPN for short).

In an embodiment, the TWAMP configuration includes: configuration of a reflecting end of an NNI-side device, and configuration of a transmitting end of a UNI-side device.

In an embodiment, the configuration of the telemetry performance index subscription includes: configuration of a sampling path and a sampling period of the telemetry for a specific interface, a CPU, an internal storage, and routing table information.

In an embodiment, when the network transmission index is acquired by the NMS through the TWAMP, collection is performed according to a NETCONF period. The NETCONF period is relatively short, and is usually 10 seconds or 20 seconds. Therefore, the network node may acquire the network transmission performance in a relatively short time period, and may report abnormal information to the network management system in time when the network transmission performance is abnormal.

In an embodiment, the network transmission index may include at least one of an index of latency time, an index of packet loss rate and an index of jitter.

In an embodiment, in response to receiving the abnormal information reported, when the network node detects that a network transmission index is abnormal, to the network management system by the network node, the network management system may determine, according to the abnormal information, a suspicious region where device performance abnormality may exist. For example, the UNI acquires the network transmission index between the UNI and the NNI through the TWAMP, and when the network transmission index obtained is abnormal, the link connected between the UNI and the NNI may be determined as the suspicious region. Network nodes between the UNI and the NNI (including the UNI and the NNI) are network nodes in the suspicious region.

In an embodiment, when the network transmission index collected by the network node is abnormal, the network node may also actively report the abnormal information to the network management system according to a telemetry protocol. Embodiments of the present application do not make any limitation on this.

In an embodiment, the abnormal information may be only used for indicating that the network transmission index is abnormal. Alternatively, the abnormal information may be used to not only indicate that the network transmission index is abnormal, but also carry the abnormal network transmission index. Embodiments of the present application do not make any limitation on this.

At step 102, an acquisition instruction is transmitted to the network node within the suspicious region.

For example, after determining the suspicious region corresponding to the abnormal information, the network management system may transmit an acquisition instruction to a network node within the suspicious region, and the acquisition instruction includes an order for acquiring a device performance index of the network node.

In an embodiment, the network management system may transmit the acquisition instruction to all of network nodes within the suspicious region, and may also transmit the acquisition instruction to some of the network nodes within the suspicious region. Embodiments of the present application do not make any limitation on this.

In an embodiment, in the case that the network management system transmits the acquisition instruction to some of the network nodes within the suspicious region, the network management system may determine a target network node within the suspicious region according to the abnormal information, so that the acquisition instruction is transmitted to the target network node within the suspicious region. It should be noted that, when the network management system transmits the acquisition instruction to the network nodes within the suspicious region, the network nodes within the suspicious region may include the network node that has reported the abnormal network transmission index, and may not include the network node that has reported the abnormal network transmission index either. Embodiments of the present application do not make any limitation on this.

At step 103, a device performance index returned, in response to the acquisition instruction, by the network node within the suspicious region is received.

In an embodiment, the network management system may transmit the acquisition instruction to one network node. Accordingly, when receiving the device performance index returned, in response to the acquisition instruction, by the network node within the suspicious region, the network management system may also receive a device performance index returned, in response to the acquisition instruction, by the one network node. The device performance index may include at least one of a processing state of a processor, a memory usage, a transmission path, a count of incoming packets, a count of outgoing packets, and a network configuration of each port.

In an embodiment, the network management system may transmit the acquisition instruction to multiple network nodes. Accordingly, when receiving the device performance index returned, in response to the acquisition instruction, by the network nodes within the suspicious region, the network management system may receive the device performance index returned, in response to the acquisition instruction, by each of the multiple network nodes.

At step 104, an abnormality analysis report is generated according to the device performance index.

For example, after acquiring the device performance index returned, in response to the acquisition instruction, by the network node, the network management system may generate the abnormality analysis report automatically according to the device performance index. The abnormality analysis report may be used for indicating that an abnormal network node exists in the communication network. The abnormality analysis report may be a text report, an image report, and may also be a voice report. Embodiments of the present application do not make any limitation on this.

In an embodiment, after generating the abnormality analysis report, the network management system may also output the abnormality analysis report to a user. For example, the abnormality analysis report may be transmitted to the user via a short message or via email.

In an embodiment, when the network management system generates the abnormality analysis report, reference may also be made to log information of the system to generate the abnormality analysis report.

According to the above network monitoring method, in response to receiving abnormal information transmitted to the network management system from network node, where the abnormal information is transmitted in response to detecting by the network node that a network transmission index is abnormal, a suspicious region is determined according to the abnormal information; an acquisition instruction including an order of acquiring a device performance index of the network node is transmitted to the network node within the suspicious region; the device performance index returned, in response to the acquisition instruction, by the network node within the suspicious region is received; and an abnormality analysis report is further generated according to the device performance index. In this way, once the abnormal information is received, the device performance index of the network node within the suspicious region can be acquired immediately, and the abnormality analysis report can be generated according to the device performance index in time, so that the operation and maintenance staff can determine a failure of the network node in time according to the abnormality analysis report.

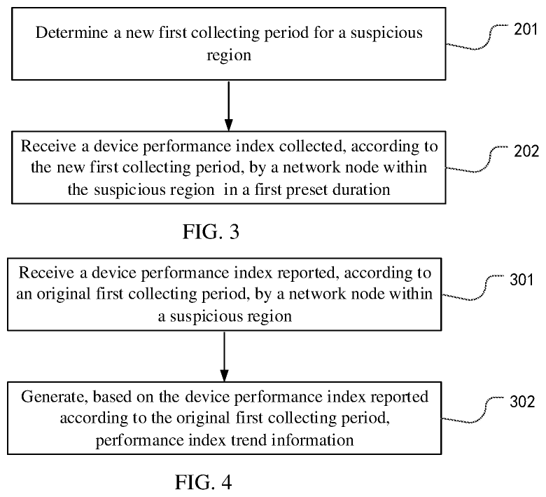

In an embodiment, when receiving the device performance index returned, in response to the acquisition instruction, by the network node within the suspicious region, the network management system may obtain a new first collecting period according to an original first collecting period, so that the number of device performance indexes that can be collected is increased within a limited time length. Details are described by way of the embodiment illustrated in FIG. 3. As shown in FIG. 3, the method further includes steps described below.

At step 201, a new first collecting period for the suspicious region is determined.

The first collecting period is used for indicating an interval duration of collecting the device performance index. The new first collecting period is shorter than an original first collecting period. The original first collecting period may be carried in a configuration instruction transmitted to the network node; and the acquisition instruction further includes the new first collecting period.

In an embodiment, the network node may collect the corresponding device performance index according to the original first collecting periods. The first collecting periods corresponding to respective network nodes may be the same, and may also be different collecting periods. Embodiments of the present application do not make any limitation on this.

In an embodiment, when the network management system issues configuration information to respective network nodes, the original first collecting period may be carried in the configuration instruction transmitted to the network node. The configuration instruction may be transmitted to the network node according to a NETCONF protocol.

In an embodiment, after receiving abnormal information transmitted from the network node, the network management system may reduce the original first collecting period to obtain the new first collecting period, and allows the new first collecting period to be carried in the acquisition instruction. When the network management system transmits the acquisition instruction to respective network nodes within the suspicious region, the new first collecting period may be issued to the respective network nodes within the suspicious region at the same time.

At step 202, the device performance index that is collected, according to the new first collecting period, by the network node within the suspicious region in a first preset duration is received.

For example, after receiving the acquisition instruction, the network node within the suspicious region may collect, according to the new first collecting period carried in the acquisition instruction, the device performance index in the first preset duration, and transmit the device performance index collected to the network management system, so that the network management system may obtain the device performance index collected, according to the new first collecting period, in the preset duration. The first preset duration may be a duration determined according to a starting time instant and an ending time instant, and may also be a duration determined according to the new first collecting period. Embodiments of the present application do not make any limitation on this.

In an embodiment, the first preset duration may be three new first collecting periods.

According to the above network monitoring method, by reducing a duration of the first collecting period for the suspicious region, the number of device performance indexes collected in the suspicious region according to the new first collecting period is increased, thereby improving the accuracy of the abnormality analysis report generated according to the device performance index(es).

In an embodiment, before the network management system receives the abnormality information reported by the network node, the device performance index may still be collected according to the original first collecting period, so as to obtain performance index trend information of the device performance index of the network node within the suspicious region. Details are described by way of the embodiment illustrated in FIG. 4. As shown in FIG. 4, the method further includes steps described below.

At step 301, the device performance index that is reported, according to the original first collecting period, by the network node within the suspicious region is received.

For example, before receiving the abnormality information reported by the network node, the network management system may issue the original first collecting period to the network node, and the network node collects the corresponding device performance index according to the original first collecting period.

In an embodiment, the network node may directly report the device performance index according to the original first collecting period. Alternatively, after receiving the acquisition instruction transmitted from the network management system, the network node transmits the device performance index that is collected, according to the original first collecting period, before receiving the acquisition instruction to the network management system. Embodiments of the present application do not make any limitation on this.

In an embodiment, when reporting the device performance index according to the original first collecting period, the network node may also selectively only report target device performance indexes greater than a threshold, so as to avoid an excessively large amount of data to be reported.

At step 302, performance index trend information is generated based on the device performance index/indexes reported according to the original first collecting period.

For example, in response to receiving the device performance index/indexes reported by the network node within the suspicious region, the network management system may determine the collecting time instant of each of the device performance indexes according to the original first collecting period, and generates the performance index trend information according to the collecting time instant of each of the device performance indexes. The performance index trend information may be graph information, text information, or animation information. Embodiments of the present application do not make any limitation on the presentation manner of the performance index information.

According to the above network monitoring method, the device performance index/indexes that are reported, according to the original first collecting period, by the network node within the suspicious region are received, and the performance index trend information is further generated based on the device performance index/indexes reported according to the original first collecting period. In this way, when determining a failure of the network node, the user may also use the performance index trend information to determine the failure of the network node more accurately.

In an embodiment, when generating the abnormality analysis report according to the device performance index/indexes, the network management system may selectively generate the abnormality analysis report.

In an embodiment, when the network transmission index meets a preset alarming condition, the network management system generates the abnormality analysis report according to the device performance index/indexes. The preset alarming condition may include that the network transmission index indicated by the abnormality information has not restored to normal within a second preset duration.

In an embodiment, when the network transmission index does not meet the preset alarming condition, for example, when the network transmission index indicated by the abnormality information restores to normal, the new first collecting period may be restored to the original first collecting period, so that the network node in the suspicious region collects the device performance index/indexes according to the original first collecting period.

According to the above network monitoring method, the abnormality analysis report is generated according to the device performance index/indexes only when the device performance index/indexes collected meets the preset alarming condition, and no abnormality analysis report is generated when the device performance index/indexes does not meet the preset alarming condition. In this way, the number of abnormality analysis reports generated is reduced, thereby avoiding a circumstance that the network management system stores an excessively amount of abnormality analysis reports.

In an embodiment, when the network transmission index is an index of latency time, the device performance index includes at least one of a processing state of a processor, a memory usage, a transmission path of the network node within the suspicious region; and when the network transmission index is an index of packet loss rate, the device performance index includes at least one of the following: a count of incoming packets, a count of outgoing packets, and a network configuration of each port of the network node within the suspicious region. The network configuration of each port may be a local area network configuration of each port.

According to the above network monitoring method, when the abnormality information collected is that the latency time is greater than a preset latency time threshold, the device performance index within the suspicious region to be acquired includes at least one of the processing state of the processor, the memory usage and the transmission path. When the abnormality information collected is that the packet loss rate is greater than a preset packet loss rate threshold, the device performance index in the suspicious region to be acquired includes at least one of the count of incoming packets, the count of outgoing packets, and the network configuration of each port of the network node within the suspicious region. Since device performance indexes, such as the processing state of the processor, the memory usage and the transmission path, are closely related to the latency time, and device performance indexes, such as the count of incoming packets, the count of outgoing packets, and the network configuration of each port of the network node in the suspicious region, are closely related to the packet loss rate, the abnormality analysis report generated has a relatively high correspondence to the abnormality information, so that the user may further determine a failure of the network node more accurately according to the abnormality analysis report.

In an embodiment, the abnormality information that is reported, based on notification information in accordance with the NETCONF protocol, by the network node is received.

The network node may report the abnormality information based on the notification information in accordance with the NETCONF protocol. Since it may be set that the notification information in accordance with the NETCONF protocol is reported according to a duration of a millisecond (ms for short) level, the network node may report the abnormality information at the duration of the millisecond level. In this way, after the network transmission index is abnormal, the network management system may receive the abnormality information reported, based on the notification information in accordance with the NETCONF protocol, by the network node in a duration of the millisecond level.

In an embodiment, before receiving the abnormality information reported by the network node, the network management system may transmit a configuration instruction to the network node. The configuration instruction includes: the network transmission index corresponding to the network node, a preset threshold corresponding to the network transmission index, the original first collecting period for the network node to collect the device performance index, and a second collecting period for the network node to collect the network transmission index. When the network transmission index exceeds the preset threshold, the network transmission index is abnormal.

In an embodiment, before receiving the abnormality information reported by the network node, for example, in a configuration stage of the network node, the network management system may transmit the configuration instruction to the network node. The configuration instruction also carries the network transmission index corresponding to the network node, the preset threshold corresponding to the network transmission index, the original first collecting period for the network node to collect the device performance index, and the second collecting period for the network node to collect the network transmission index. When the network transmission index exceeds the preset threshold, the network transmission index is abnormal. It should be noted that, one network node may correspond to one network transmission index, or correspond to multiple network transmission indexes. Embodiments of the present application do not make any limitation on this.

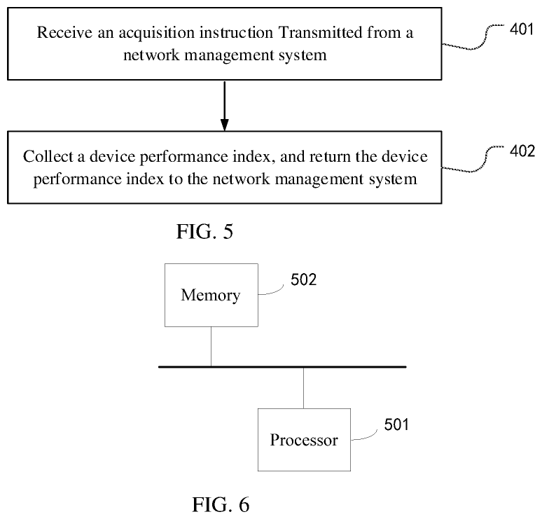

The above embodiment describes a specific implementation process of determining the network performance abnormality by the network management system in time. How to report, by the network node, the abnormality information to the network management system is described in detail below by way of the following embodiment. As shown in FIG. 5, the network monitoring method includes steps described below.

At step 401, the acquisition instruction transmitted from the network management system is received.

At step 402, the device performance index is collected and returned to the network management system.

In an embodiment, before the above step 401, when the network transmission index is abnormal, the network node may inform the network management system of the abnormality information for indicating that the network transmission index is abnormal.

In an embodiment, the acquisition instruction may further include a new first collecting period, and the new first collecting period is shorter than an original first collecting period. The first collecting period is used for indicating an interval duration of collecting the device performance index. At the above step 402, the device performance index is collected in the following manner: the device performance index is collected, according to the new first collecting period, in a preset duration.

In an embodiment, the network node may report the device performance index of the network node according to the original first collecting period.

In an embodiment, before receiving the acquisition instruction transmitted from the network management system, for example, before informing the network management system of the abnormality information for indicating that the network transmission index is abnormal, the network node may also first receive the configuration instruction issued by the network management system, and configures, according to the configuration instruction, the network transmission index required to be collected by the network node, a preset threshold corresponding to the network transmission index, the original first collecting period for collecting the device performance index, and a second collecting period for collecting the network transmission index. Optionally, the configuration instruction transmitted from the network management system is received; and the configuration instruction includes the network transmission index corresponding to the network node, the preset threshold corresponding to the network transmission index, the original first collecting period for the network node to collect the device performance index, and the second collecting period for the network node to collect the network transmission index. When the network transmission index exceeds the preset threshold, the network transmission index is abnormal.

It should be noted that, the above respective embodiments are examples provided for better understanding, and do not constitute any limitation to the technical solution of the disclosure.

The above division of various steps of the method is only for the purpose of clear description. In implementation, steps may be combined into one step, or a step may be divided into multiple steps. The division of the steps falls into the protection scope of the disclosure as long as the same logical relationship is included. Adding inessential modifications or introducing inessential design to the algorithm or the process without changing the core design of the algorithm or the process is also within the protection scope of the disclosure.

An embodiment of the present application relates to an electronic device, as shown in FIG. 6, which includes at least one processor 501, and a memory 502 communicatively connected to the at least one processor 501. The memory 502 is configured to store an instruction executable by the at least one processor 501, and the instruction is executed by the at least one processor 501 to enable the at least one processor 501 to implement steps illustrated in the above method embodiments.

The memory 502 and the processor 501 are connected through a bus. The bus may include any number of interconnected buses and bridges. The bus connects various circuits of one or more processors 501 and the memory 502 together. The bus may also connect various other circuits together, such as a peripheral device, a voltage stabilizer, and a power management circuit. These are known in the art, and further description will not be provided in the disclosure. A bus interface is provided between the bus and a transceiver. The transceiver may be one element and may also be multiple elements, for example, multiple receivers and transmitters. The transceiver provides a unit for communicating with various other apparatuses over a transmission medium. Data processed by the processor 501 is transmitted over a wireless medium via an antenna, and further the antenna further receives data and transmits the data to the processor 501.

The processor 501 is configured to manage the bus and regular processing, and may also provide various functions including timing, peripheral interface, voltage regulation, power management, and other control functions. The memory 502 may be used to store data used by the processor 501 when performing operations.

An embodiment of the present application relates to a computer readable storage medium storing a computer program. The computer program, when executed by a processor, is used to implement the above method embodiments.

That is, those skilled in the art may understand that all or some steps of the above method embodiments may be implemented by instructing relevant hardware through the program. The program is stored in a storage medium, and includes several instructions to cause a device (which may be a single-chip computer, a chip and the like) or a processor to carry out all or some steps of the above method in respective embodiments of the application. The foregoing storage medium includes various mediums which can store program codes, such as a USB flash disk, a mobile hard disk drive, a read-only memory (ROM), a random access memory (RAM), a magnetic disk, or an optical disk, and the like.

Those skilled in the art may understand that, the above various embodiments are specific embodiments for implementing the application, but in actual application various changes can be made to the embodiments in forms and details without departing from the spirit and the scope of the application.

1. A network monitoring method, applied to a network management system and comprising:
in response to receiving abnormal information reported by a network node, determining a suspicious region according to the abnormal information, wherein the abnormal information is transmitted to the network management system from the network node in response to detecting by the network node that a network transmission index is abnormal;
transmitting an acquisition instruction to the network node within the suspicious region, wherein the acquisition instruction comprises an order for acquiring a device performance index of the network node;
receiving the device performance index returned, in response to the acquisition instruction, by the network node within the suspicious region; and
generating an abnormality analysis report according to the device performance index.

2. The method according to claim 1, further comprising:
determining a new first collecting period for the suspicious region, wherein the first collecting period is used for indicating an interval duration of collecting the device performance index, and the new first collecting period is shorter than an original first collecting period;
wherein the acquisition instruction further comprises the new first collecting period;
wherein the receiving the device performance index returned, in response to the acquisition instruction, by the network node within the suspicious region comprises:
receiving the device performance index collected, according to the new first collecting period, by the network node within the suspicious region in a first preset duration.

3. The method according to claim 2, further comprising:
receiving the device performance index reported, according to the original first collecting period, by the network node within the suspicious region; and
generating, based on the device performance index reported according to the original first collecting period, performance index trend information.

4. The method according to claim 1, wherein the generating an abnormality analysis report according to the device performance index comprises:
generating the abnormality analysis report according to the device performance index in response to determining that the network transmission index meets a preset alarming condition.

5. The method according to claim 4, wherein the preset alarming condition comprises that the network transmission index indicated by the abnormal information is not restored to normal in a second preset duration.

6. The method according to claim 1, wherein when the network transmission index is an index of latency time, the device performance index comprises at least one of a memory usage, a transmission path, a processing state of a processor of the network node within the suspicious region; and when the network transmission index is an index of packet loss rate, the device performance index comprises at least one of a count of incoming packets, a count of outgoing packets, and a network configuration of each port of the network node within the suspicious region.

7. The method according to claim 1, wherein the receiving abnormal information reported by a network node comprises:
receiving the abnormal information reported, based on notification information in accordance with a NETCONF protocol, by the network node.

8. The method according to claim 1, wherein before receiving the abnormal information reported by the network node, the method further comprises:
transmitting a configuration instruction to the network node;
wherein the configuration instruction carries the network transmission index corresponding to the network node, a preset threshold corresponding to the network transmission index, an original first collecting period for the network node to collect the device performance index, and a second collecting period for the network node to collect the network transmission index; and wherein when the network transmission index exceeds the preset threshold, the network transmission index is abnormal.

9. A network monitoring method, applied to a network node and comprising:
receiving an acquisition instruction transmitted from a network management system, wherein the acquisition instruction comprises an order for acquiring a device performance index of the network node; and
collecting the device performance index, and returning the device performance index to the network management system.

10. The method according to claim 9, wherein before receiving the acquisition instruction transmitted from the network management system, the method further comprises:
in response to determining that a network transmission index is abnormal, reporting abnormal information for indicating that the network transmission index is abnormal to the network management system.

11. The method according to claim 9, wherein the acquisition instruction further comprises a new first collecting period, wherein the new first collecting period is shorter than an original first collecting period, and the first collecting period is used for indicating an interval duration of collecting the device performance index; and
wherein the collecting the device performance index comprises:
collecting, according to the new first collecting period, the device performance index in a first preset duration.

12. The method according to claim 11, further comprising:
reporting, according to the original first collecting period, the device performance index of the network node.

13. The method according to claim 9, wherein before receiving the acquisition instruction transmitted from the network management system, the method further comprises:
receiving a configuration instruction transmitted from the network management system, wherein the configuration instruction comprises a network transmission index corresponding to the network node, a preset threshold corresponding to the network transmission index, an original first collecting period for the network node to collect the device performance index, and a second collecting period for the network node to collect the network transmission index, and wherein when the network transmission index exceeds the preset threshold, the network transmission index is abnormal.

14. A network device, comprising:
at least one processor; and
a memory communicatively connected to the at least one processor,
wherein the memory is configured to store an instruction executable by the at least one processor, and the instruction is executed by the at least one processor to enable the at least one processor to implement the following steps:
in response to receiving abnormal information reported by a network node, determining a suspicious region according to the abnormal information, wherein the abnormal information is transmitted to the network management system from the network node in response to detecting by the network node that a network transmission index is abnormal;
transmitting an acquisition instruction to the network node within the suspicious region, wherein the acquisition instruction comprises an order for acquiring a device performance index of the network node;
receiving the device performance index returned, in response to the acquisition instruction, by the network node within the suspicious region; and
generating an abnormality analysis report according to the device performance index.

15. A non-transitory computer readable storage medium with a computer program stored thereon, wherein the computer program, when executed by a processor, causes to implement the network monitoring method according to claim 1.

16. A network device, comprising:
at least one processor; and
a memory communicatively connected to the at least one processor,
wherein the memory is configured to store an instruction executable by the at least one processor, and the instruction is executed by the at least one processor to enable the at least one processor to implement the network monitoring method according to claim 10.
